(19) United States
(12) Patent Application Publication
(10) Pub. No.: US 2005/0157316 A1
(43) Pub. Date: Jul. 21, 2005

(54) Image printing method

(76) Inventor: Guo-Tai Chen, Taipei (TW)

Correspondence Address: RABIN & BERDO, P.C., Suite 500, 1101 14th Street, N.W., Washington, DC, 20005, US

(21) Appl. No.: 10/759,295

(22) Filed: Jan. 20, 2004

(51) Int. Cl. G06F 15/00

(52) U.S. Cl. 358/1.2; 358/1.13

(57) ABSTRACT

An image printing method is disclosed for applications in printer drivers and printers. The image printing method performs various image processing such as shrinking, magnification, and cutting on an image using the printer driver. The processed image is sent via several packets to the printer for the printer to perform relevant image processing. This saves a lot of memory space. Moreover, the transmission time between the printer driver and the printer is reduced.

### BACKGROUND OF THE INVENTION

1. Field of Invention

The invention relates to a printing method for printer drivers and printers and, in particular, to an image printing method.

2. Related Art

When using a printer to print an image, the printer driver has to transmit the original image to the printer. If one wants to print a shrunk or magnified image, the printer driver has to shrink or magnify it first before sending the image to the printer for printing. If the image should be cut, the printer driver also does the job after shrinking or magnification and before sending it to the printer.

Of course, if the magnification ratio between the resulting image and the original image is too large, a lot of memory space will be used for storage. The transmission time for sending the image from the printer driver to the printer is also longer. The processing time therefore cannot be reduced.

### SUMMARY OF THE INVENTION

A primary objective of the invention is to provide an image printing method that reduces the usage of memory space and the transmission time between the printer driver and the printer. The processing speed can thus be increased.

The disclosed image printing method is used in printer drivers and printers. Here we define the original, the resulting image, the cutting block, and the correspondence block. The original image is the initial image for the printer driver to process. The original image data include an original initial point, an original length, and an original width. The resulting image is the image obtained after the printer driver magnifies and shrinks the original image. The resulting image data include a resulting initial point, a resulting length, and a resulting width. The cutting block is the image cut from the resulting image. The area correspondence relation between the correspondence block and the original image is the same as the area correspondence relation between the cutting block and the resulting image.

According to the disclosed method, the printer driver first obtains original image data, resulting image data, and cutting block data. The printer driver computes a resizing ratio between the resulting image data and the original image data. The printer driver further confirms that the resizing ratio is greater than one.

Afterwards, the printer driver computes the intersection of the resulting image and the cutting block to obtain the cutting block. The printer driver then uses the area correspondence relation between the cutting block data and the resulting image data to compute the correspondence block data that has the same area correspondence relation with the original image data. The printer driver computes an error displacement according to the cutting block data and the correspondence block data. Afterwards, the printer driver transmits the correspondence block data, the error displacement, and the resizing ratio to the printer.

After the printer receives the correspondence block data, the error displacement, and the resizing ratio, it performs image magnification and block cutting accordingly. Finally, the printer prints the cutting block.

The image processed by the printer driver is sent to the printer for the printer to perform relevant image processing. This saves a lot of memory space. The transmission time between the printer driver and the printer is thus shortened.

### BRIEF DESCRIPTION OF THE DRAWINGS

The invention will become more fully understood from the detailed description given hereinbelow illustration only, and thus are not limitative of the present invention, and wherein:

FIG. 1 shows schematic views of the original image and the resulting image;

FIGS. 2A and 2B are flowcharts of the disclosed image printing method;

FIG. 3 is a schematic view of the original image, the resulting image, the cutting block, and the correspondence block; and

FIGS. 4A, 4B, 4C are another set of flowcharts of the disclosed image printing method.

### DETAILED DESCRIPTION OF THE INVENTION

The disclosed image printing method is used in printer drivers and printers.

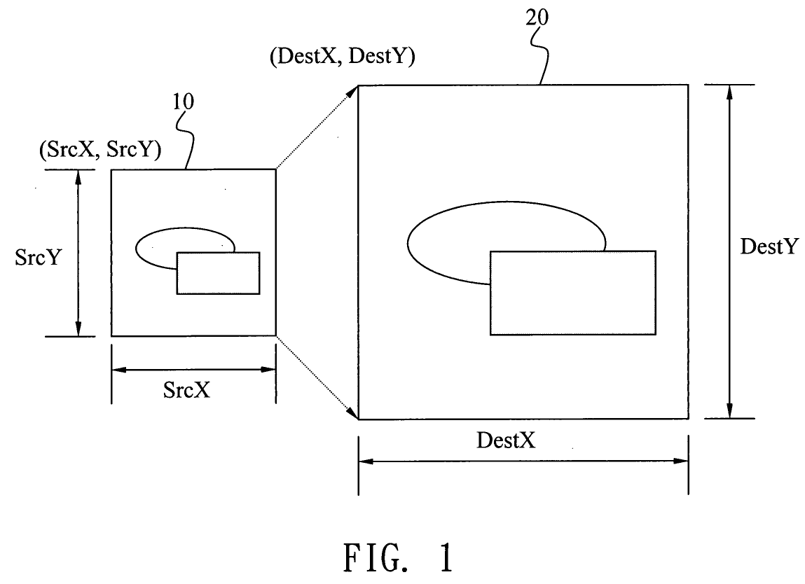

With reference to FIG. 1, the original image 10 is the initial image the printer driver processes. The original image 10 includes an original initial point (SrcX,SrcY), an original length (SrcY), and an original width (SrcX). The resulting image 20 is the image obtained after the printer driver resizes the original image. It contains a resulting initial point (DestX, DestY), a resulting length (DestY), and a resulting width (DestX).

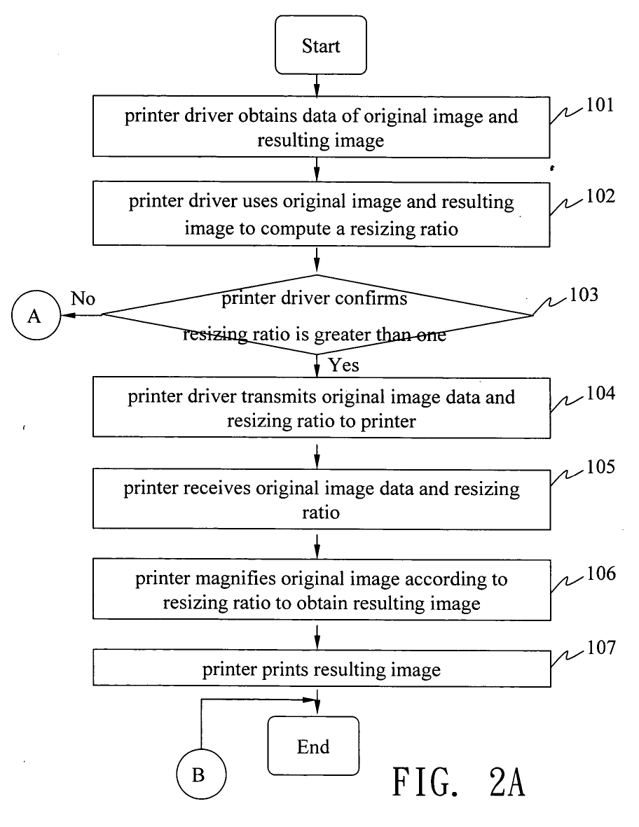

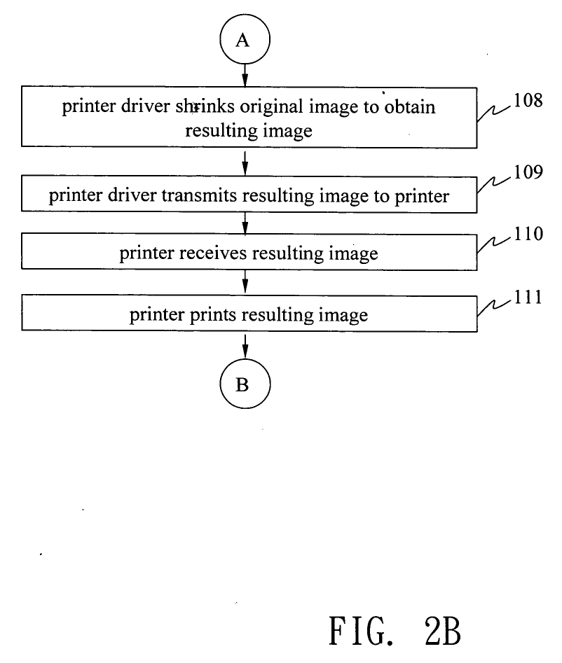

The flowcharts of the disclosed image printing method are shown in FIGS. 2A and 2B. They show the procedure of shrinking or magnifying the original image. The method includes the following steps, with simultaneous reference to FIG. 1 for the original image and the resulting image.

First, the printer driver obtains the data of the original image and the resulting image (step 101). The data contained therein have been described before. The printer driver uses the original image and the resulting image to compute a resizing ratio (step 102). That is, a shrinking or magnifying power is computed by taking the original image as the standard. The printer driver then confirms the resizing ratio is greater than one (step 103). If it is greater than one, the original image has to be magnified to obtain the resulting image, followed by performing step 104. If it is not greater than one, the original image has to be shrunk to obtain the resulting image. Therefore, the printer driver shrinks the original image to obtain the resulting image (step 108). The printer driver transmits the resulting image to the printer (step 109). The printer receives the resulting image (step 110) and prints the resulting image (step 111). Therefore, the printer can print the resulting image once it is obtained after performing image shrinkage by the printer driver.

The printer driver transmits the original image data and the resizing ratio to the printer (step 104) for subsequent processes. The printer then receives the original image data and the resizing ratio (step 105). The printer magnifies the original image according to the resizing ratio to obtain the resulting image (step 106). Finally, the printer prints the resulting image (step 107).

After the printer driver performs image processing on the original image, the result is transmitted to the printer. Afterwards, the printer performs related image processing. This solves the problem of large memory space wasting. The transmission time between the printer driver and the printer can be largely saved.

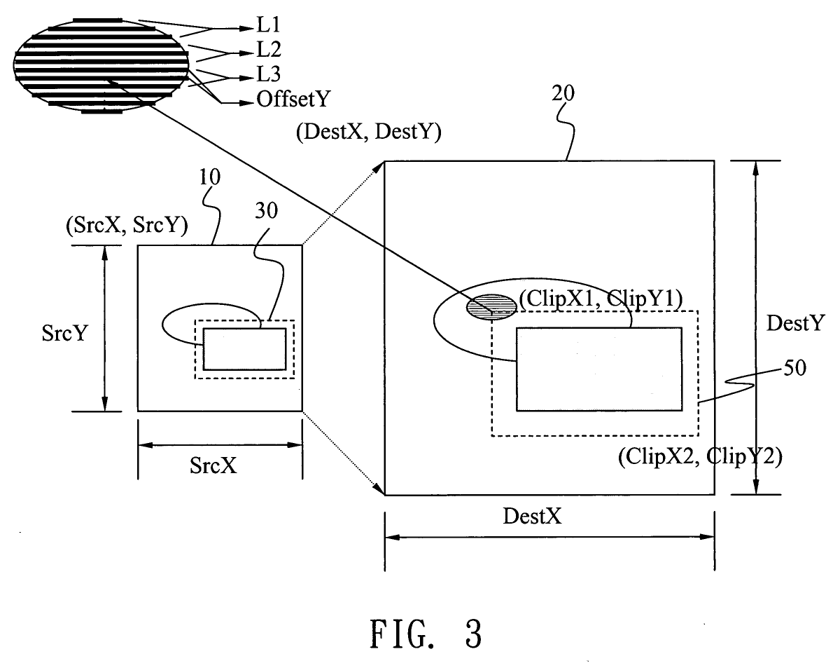

With reference to FIG. 3, the original image 10 is the initial image being processed by the printer driver. The data of the original image 10 include an original initial point (SrcX,SrcY), an original length (SrcY), and an original width (SrcX). The resulting image 20 is the image obtained after the printer driver resizes the original image. The data of the resulting image 20 include a resulting initial point (DestX, DestY), a resulting length (DestY), and a resulting width (DestX). The cutting block 20 is an image cut from the resulting image 20. The area correspondence relation between the correspondence block 30 and the original image 10 is the same as that between the cutting block 50 and the resulting image 20.

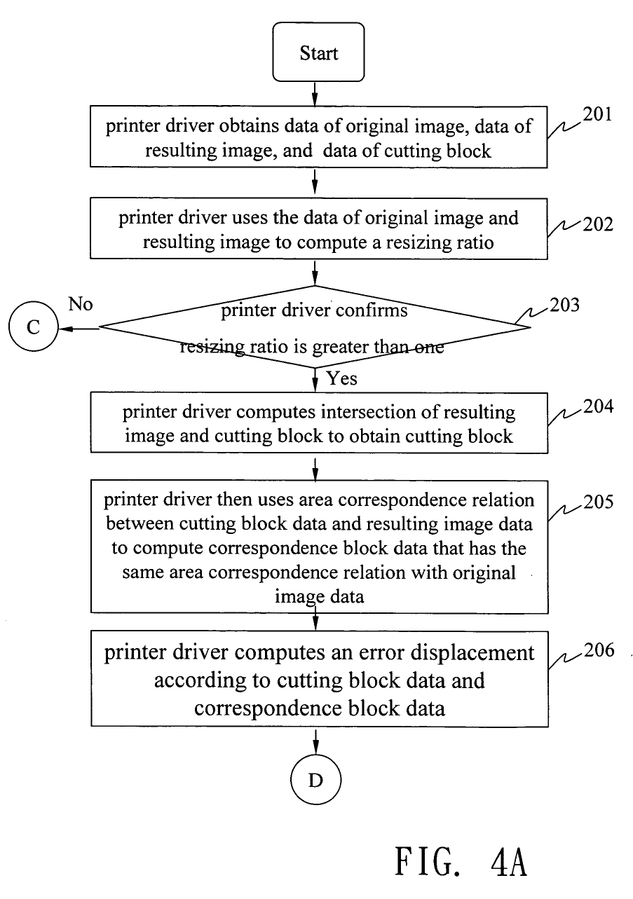

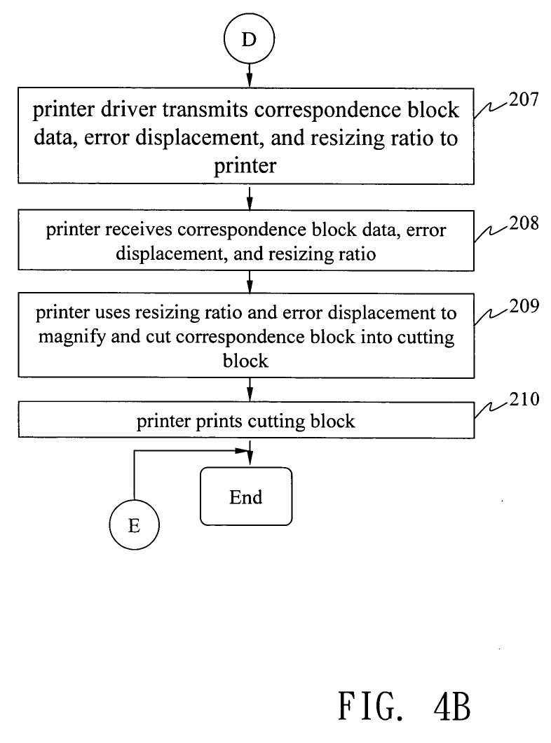

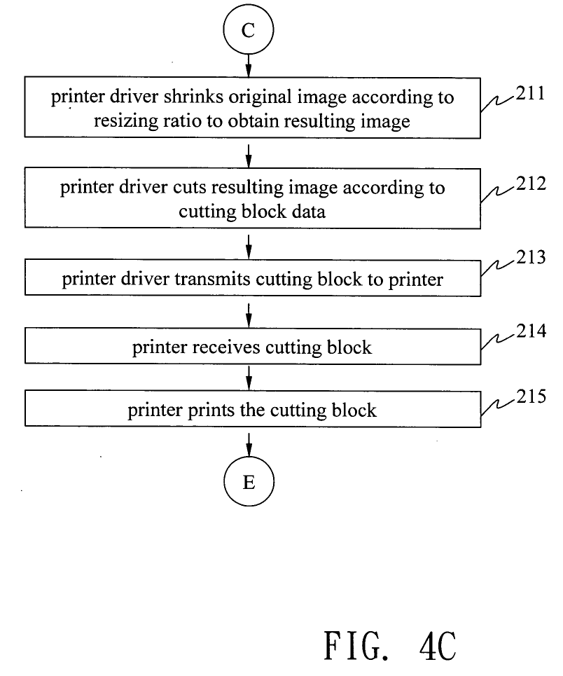

FIGS. 4A, 4B, 4C show another set of flowcharts of the disclosed image printing method. They shrink or magnify the original image and perform image cutting. The method includes the following steps, with simultaneous reference to FIG. 3 for the original image, the resulting image, the cutting block, and the correspondence block.

First, the printer driver obtains the data of the original image, the data of the resulting image, and the data of the cutting block (step 201) for subsequent processes. The printer driver uses the data of the original image and the resulting image to compute a resizing ratio (step 202). That is, a shrinking or magnifying power is computed by taking the original image as the standard.

The printer driver then confirms the resizing ratio is greater than one (step 203). If it is greater than one, the original image has to be magnified to obtain the resulting image, followed by performing step 204. If it is not greater than one, the original image has to be shrunk to obtain the resulting image. Therefore, the printer driver shrinks the original image according to the resizing ratio to obtain the resulting image (step 211). The printer driver cuts the resulting image according to the cutting block data (step 212). The printer driver transmits the cutting block to the printer (step 213). The printer receives the cutting block (step 214) and prints the cutting block (step 215). Therefore, the printer can print the cutting block once it is obtained after performing image shrinkage and image cutting by the printer driver.

The printer driver computes the intersection of the resulting image and the cutting block to obtain the cutting block (step 204). The printer driver then uses the area correspondence relation between the cutting block data and the resulting image data to compute the correspondence block data that has the same area correspondence relation with the original image data (step 205). That is, the image processing makes use of the area correspondence relation between the cutting block data and the resulting image data to obtain that between the original image and the correspondence block.

The printer driver computes an error displacement according to the cutting block data and the correspondence block data (step 206). As shown in the drawing, if the resizing ratio is 3 (i.e. magnifying by a factor of 3), the lines L1, L2, and L3 in the original image are also magnified by a factor of 3. The second line of L3 is the effective line, which is the error displacement OffsetY in length. The width is analogous.

The printer driver transmits the correspondence block data, the error displacement, and the resizing ratio to the printer (step 207). Afterwards, the printer receives the correspondence block data, the error displacement, and the resizing ratio (step 208). The printer uses the resizing ratio and the error displacement to magnify and cut the correspondence block into the cutting block (step 209). Finally, the printer prints the cutting block (step 210).

After the printer driver performs image processing on the original image, the result is transmitted to the printer. Afterwards, the printer performs related image processing. This solves the problem of large memory space wasting. The transmission time between the printer driver and the printer can be largely saved.

Certain variations would be apparent to those skilled in the art, which variations are considered within the spirit and scope of the claimed invention.

1. An image printing method for a printer driver and a printer, the image printing method comprising the steps of:
(1) obtaining data of an original image and data of a resulting image by the printer driver, wherein the data of the original image include an original initial point, an original length, and an original width, the data of the resulting image include a resulting initial point, a resulting length, and a resulting width, and the resulting image is obtained after the printer driver resizes the original image;
(2) using the data of the original image and the data of the resulting image to compute a resizing ratio by the printer driver;
(3) confirming the resizing ratio is greater than one by the printer driver;
(4) transmitting the data of the original image and the resizing ratio to the printer by the printer driver;
(5) receiving the data of the original image and the resizing ratio by the printer;
(6) magnifying the original image according to the resizing ratio to obtain the resulting image by the printer; and
(7) printing the resulting image by the printer.

2. The method of claim 1, wherein when the result of step (3) is negative, further comprising the steps of:
shrinking the original image according to the resizing ratio to obtain the resulting image by the printer driver;
transmitting the resulting image to the printer by the printer driver;
receiving the resulting image by the printer; and
printing the resulting image by the printer.

3. An image printing method for a printer driver and a printer, the image printing method comprising the steps of:
(1) obtaining data of an original image and data of a resulting image by the printer driver and data of a cutting block, wherein the data of the original image include an original initial point, an original length, and an original width, the data of the resulting image include a resulting initial point, a resulting length, and a resulting width, and the resulting image is obtained after the printer driver resizes the original image, and the data of the cutting block cut from the resulting image;
(2) using the data of the original image and the data of the resulting image to compute a resizing ratio by the printer driver;
(3) confirming the resizing ratio is greater than one by the printer driver;
(4) computing the intersection of the resulting image and the cutting block to obtain the cutting block by the printer driver;
(5) using the area correspondence relation between the cutting block data and the resulting image data to compute the data of a correspondence block that has the same area correspondence relation with the original image data by the printer driver;
(6) computing an error displacement according to the cutting block data and the correspondence block data by the printer driver;
(7) transmitting the data of the correspondence block, the error displacement, and the resizing ratio to the printer by the printer driver;
(8) receiving the data of the correspondence block, the error displacement, and the resizing ratio by the printer;
(9) magnifying the correspondence block according to the resizing ratio and the error displacement to obtain the cutting block by the printer; and
(10) printing the cutting block by the printer.

4. The method of claim 3, wherein when the result of step (3) is negative, further comprising the steps of:
shrinking the original image according to the resizing ratio to obtain the resulting image by the printer driver;
cutting the resulting image according to the cutting block data by the printer driver;
transmitting the cutting block to the printer by the printer driver;
receiving the cutting block by the printer; and
printing the cutting block by the printer.
